(19) United States
(12) Patent Application Publication
(10) Pub. No.: US 2005/0023723 A1
(43) Pub. Date: Feb. 3, 2005

(54) Structure for outsole-making process

(76) Inventor: Shih-Chu Huang, Taipei (TW)

Correspondence Address: Apex Juris, pllc, 13194 Edgewater Lane Northeast, Seattle, WA, 98125, US

(21) Appl. No.: 10/613,318

(22) Filed: Jul. 7, 2003

(51) Int. Cl. B29D 31/50; B29C 71/02

(52) U.S. Cl. 264/236; 264/244; 156/245

(57) ABSTRACT

The present invention relates to an outsole-making process, wherein the materials for outsole and central pad are refined. There is an opening at the front thenar of the outsole. The central pad and the outsole are placed inside the bottom of the mold sequentially with the central pad inset into the opening of the outsole. After putting on the cover, the mold is shaped up through the process of heat and sulphuration. Finally, the finished outsole is taken out for inspection and trimming before shipment.

### BACKGROUND OF THE INVENTION

1. Field of the Invention

The present invention relates to a structural improvement for outsoles characterized in ultra flexibility, weariness resistance, slip proof and tortuosity, giving more comfort and security to shoe wearers.

2. Description of the Priort Art

As the competition of the market becomes keener and keener, shoe-making technology advances and consumption consciousness awakens, consumers' requirement for shoes' quality becomes more critical.

Outsole-making technology nowadays focuses on high flexibility, slip proof and high tortuosity. Meanwhile, the balance between quality and functionality must be met through the use of materials of different hardness that go with thenar.

To make an outsole with the above functionalities, current manufacturing methods adopt the method of U.S. Pat. No. 5,725,823, which is stated as below:
1. Refine the first material (Balata) for the main outsole which is then trimmed to adequate sizes;
2. Refine the second material for the part of the front thenar which is then trimmed to adequate sizes. This material is harder than the first material;
3. Preheat the mold of the outsole, which is then filled with the second material and then covered with the first material. Having the materials shaped up by means of heating and vulcanization, and then take it out for trimming before shipment.

The balata used for the front thenar is harder; therefore, its weariness resistance, slip proof, flexibility and tortuosity are worse, thus reduces the comfort and security for the shoe-wearer.

In view of such disadvantages, the inventor of the present invention was devoted to finding a solution and accomplished structural improvement for outsoles.

### SUMMARY OF THE INVENTION

The main objective for the present invention is to provide an outsole characterized in ultra flexibility, weariness resistance, slip proof and tortuosity, giving more comfort and security to the shoe wearers.

Another objective for the present invention is to provide a manufacturing method for outsoles that saves time and material as well as produces outsoles with high functionality. To manufacture the above outsoles, you should prepare necessary equipment and materials. The equipment is a mold with a bottom and a cover. Inside the bottom there is a frame designed for the outsole's shape and a groove. Refine the materials and trim them into adequate sizes for the main outsole and the central pad respectively. Place the central pad and the main outsole sequentially inside the bottom of the mold. Make sure the outsole fits into the frame while the central pad fits leaning against the groove and that the central pad is inset into the opening of the outsole. Put on the cover and put the mold through the process of heating and vulcanization so that the outsole and the central pad are combined together. Take out the finished outsole and inspect and trim adequately before shipment.

In the following, the embodiment illustrated is used to describe the detailed structural characteristics and operation action for the present invention.

### BRIEF DESCRIPTION OF THE DRAWINGS

The drawings disclose an illustrative embodiment of the present invention which serves to exemplify the various advantages and objects hereof, and are as fellow:

FIG. 1 is a three-dimensional illustration for the structure of the present invention.

FIG. 2 is an illustration for the flowchart of the present invention.

### DETAILED DESCRIPTION OF THE INVENTION

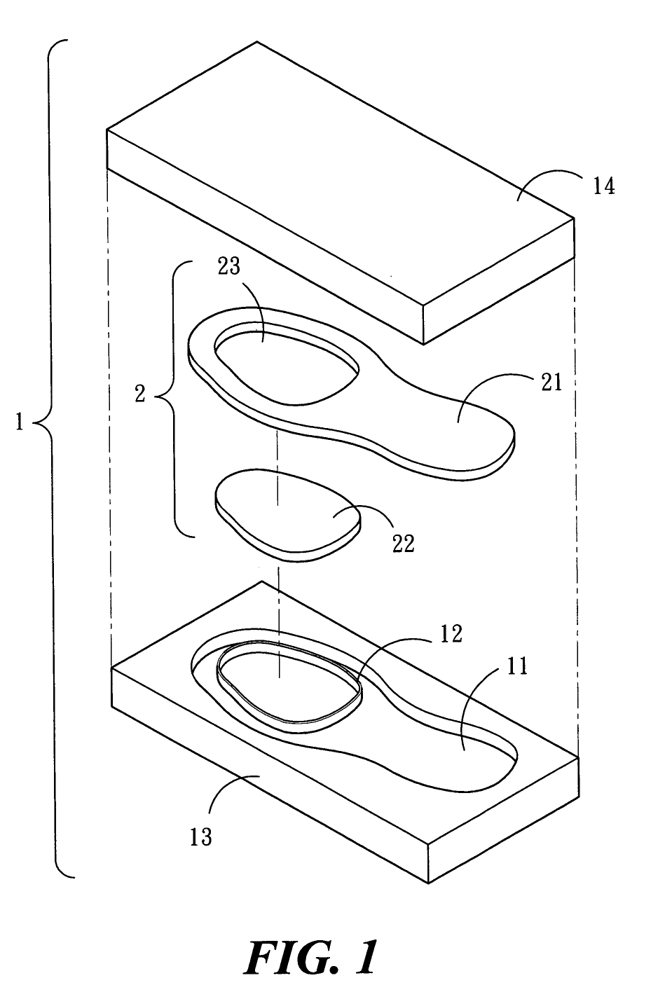

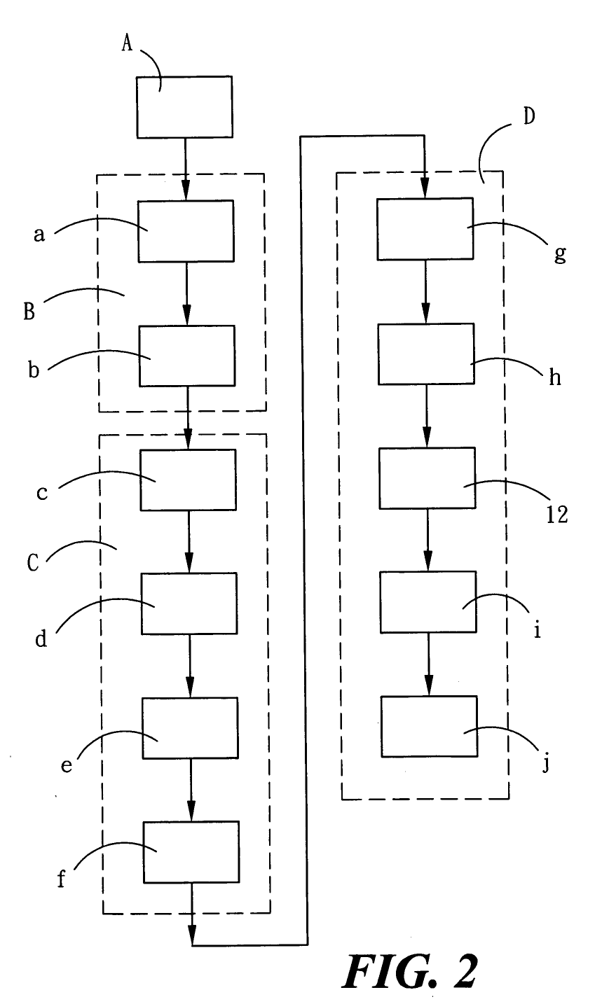

Please refer to FIG. 1 and FIG. 2. The outsole-making processing for the present invention states as follows:
(A) Preparation for equipment and materials
   The manufacturing for the present invention requires a mold 1 and the raw materials for the outsole 2. The mold 1 consists of a bottom 13 and a cover 14. The bottom 13 has a frame 11 and a groove 12. The frame 11 is used for placement of the main outsole 21 and the groove 12 is used for placement of the central pad 22. Put on the cover 14 after the placement of the main outsole 21 and the central pad 22 to put it through the process of heating and vulcanization.
(B) Making materials for the outsole
   a. Refine the raw materials and trim them into the size of the main outsole 21 according to the size of the outsole 2. The thickness shall be 3 mm and the hardness shall be obtained through of 70° C.±2° C. heating. There is an opening 23 at the front thenar of the main outsole 21.
   b. Refine the raw materials to get the materials for the central pad 22. Trim it to adequate sizes according to the front thenar. The thickness of the central pad shall be 3 mm. Place the central pad 22 into the opening 23 of the main outsole 21.
(C) Position the outsole
   c. Preheat the mold 1 under 150° C.±5° C. with the pressure of 150 kg/cm2.
   d. Place the central pad 22 flatly and steadily inside the groove 12 of the bottom 13.
   e. Place the main outsole 21 flatly and steadily inside the frame 11 of bottom 13 of the mold.
   f. Place the central pad 22 at the opening 23 of the main outsole 21 with the inner edge of the opening 23 leaning against outside the groove 12, lest the color of the main outsole 21 and the central pad 22 mix.
(D) Heating and vulcanization.
   g. Put on the cover 14 of the mold 1.
   h. Heat the mold 1 for 8-12 seconds with once to twice exhaustion during the heating.
   i. Cool it for 240-300 seconds to have the mold shaped up.
   j. Take out the outsole 2 for inspection and trimming.
   k. Through the above process would finalize the outsole 2.

Compared with traditional outsole-making process, the outsole-making process for the present invention not only saves time and materials, but produces outsoles with ultra flexibility, weariness resistance, slip proof and tortuosity, giving more comfort and security to the ones wearing the shoe.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. An outsole-making process which comprises steps of:
a. refining materials; trimming materials of main outsole according by size of said outsole; setting openings in hollow sustainer of front thenar of said main outsole;
b. refining materials; trimming a central pad according by size of said sustainer of front thenar;
c. preheating a mold;
d. placing and positioning said central pad into a groove of bottom of said mold;
e. placing said main outsole into a frame of said bottom of said mold to fill up said opening with said central pad;
f. covering up a cover of said mold and having said inner materials shaped up by means of heating and vulcanization;
g. taking out said outsole for trimming and inspection.

2. The improved outsole-making process of claim 1, wherein the hardness of said material of central pad is lower than said material of main outsole.

3. The improved outsole-making process of claim 1, wherein said heating and vulcanization requires 8-12 seconds for heating with once to twice exhaustion.

4. The improved outsole-making process of claim 1, wherein said heating and vulcanization requires 240-300 seconds for formation.

5. The improved outsole-making process of claim 1, wherein said manufacturing process of said main outsole and said central pad can be switched.
